(19) United States
(12) Patent Application Publication
(10) Pub. No.: US 2009/0308158 A1
(43) Pub. Date: Dec. 17, 2009

(54) Optical Accelerometer

(76) Inventor: Arnold D. Bard, Long Branch, NJ (US)

Correspondence Address: KEITH D. NOWAK, CARTER LEDYARD & MILBURN LLP, 2 WALL STREET, NEW YORK, NY, 10005, US

(21) Appl. No.: 12/138,522

(22) Filed: Jun. 13, 2008

(51) Int. Cl. G01P 15/00

(52) U.S. Cl. 73/514.26

(57) ABSTRACT

An optical accelerometer including a light source, a light detector and a flexible medium positioned between the light source and the light detector. The flexible medium has an opening through which the light beam from the light sources passes with the light beam being detected by the light detector. Movement by the flexible medium in response to acceleration or deceleration varies the intensity of the light beam detected by the light detector.

### FIELD OF THE INVENTION

The present invention is directed to an optical accelerometer (OA) that generates a change in its electrical signal when the OA experiences any acceleration or deceleration. More particularly the OA is mounted on a platform, (e.g. an automobile) and monitors the acceleration or deceleration of the platform when the platform is in motion. The electrical signal that is generated by the OA is proportional to the amount of acceleration or deceleration the OA experiences. This electrical signal is sent to an electronic controller and the controller processes the signal to perform a specific function such as operating as an electronic switch or potentiometer.

### BACKGROUND OF THE INVENTION

There are various types of accelerometers, which perform a similar function as the accelerometer of the present invention including the strain gage and the semiconductor types of accelerometers. All of these accelerometers provide an analog or digital signal proportional to the amount of acceleration or deceleration. However these known accelerometers have the disadvantage of being high cost, complex and are typically unidirectional.

It is therefore an object of the present invention to provide an accelerometer that is accurate, omni directional (x-y axis), low cost, simple to manufacture and has advantages not possible with prior art accelerometers.

### SUMMARY OF THE INVENTION

The present invention comprises an optical accelerometer including a light source, a light detector and a flexible medium positioned between the light source and the light detector. The flexible medium has an opening that permits a light beam from the light source to reach the light detector. When the flexible medium moves or shifts in response to acceleration or deceleration the intensity of the light beam detected by the light detector varies.

### BRIEF DESCRIPTION OF THE DRAWINGS

FIG. 1 is a block diagram of the present invention, and

FIGS. 2-4 illustrate various embodiments of the present invention.

### DESCRIPTION OF THE PREFERRED EMBODIMENT

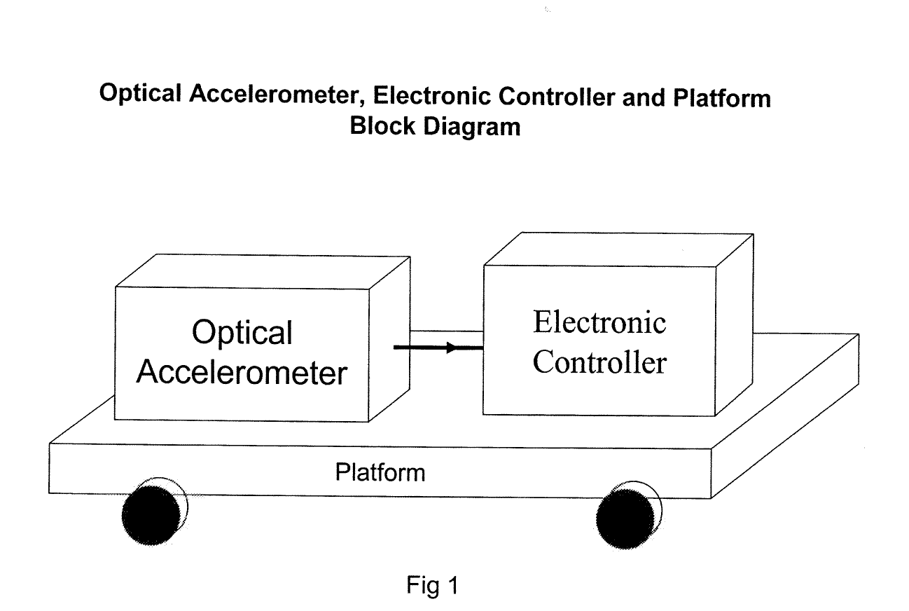

FIG. 1 is a block diagram of the OA, platform and electronic controller. The signal generated by the OA is applied to the electronic controller, which in turn is used to operate a device such as an electronic switch or a potentiometer.

The OA consists of a light source (e.g. light emitting diode (LED)), a light detector (e.g. photo detector), a structure that has two plates (a base plate and a shifting plate) and a flexible medium (e.g. foam, spring) that is attached to the two plates. The plates are used for mounting the light source and light detector with the base plate being mounted on the platform. The light beam that is generated by the light source is directed towards the light detector when the OA is not experiencing any acceleration or deceleration. As long as the light source is mounted on one of the plates and the light detector is mounted on the other plate, it does not matter on which plate they are mounted. The following describes various implementations of the OA. In certain implementations, it is possible to integrate the base plate into the platform and an actual base plate may not be necessary as described below.

Flexible Medium OA (FMOA)

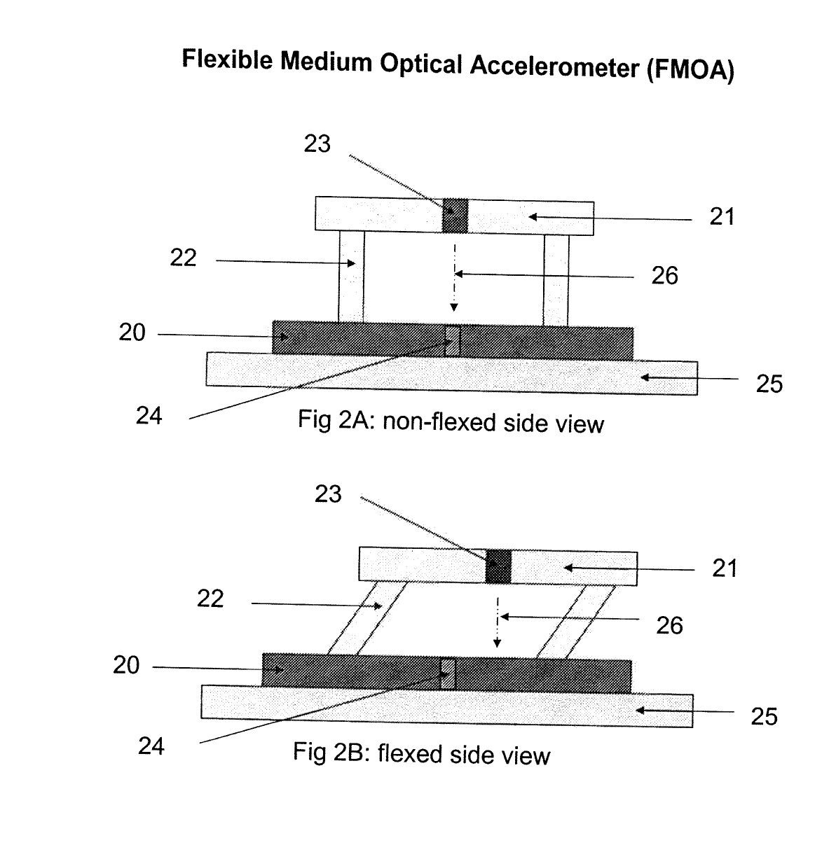

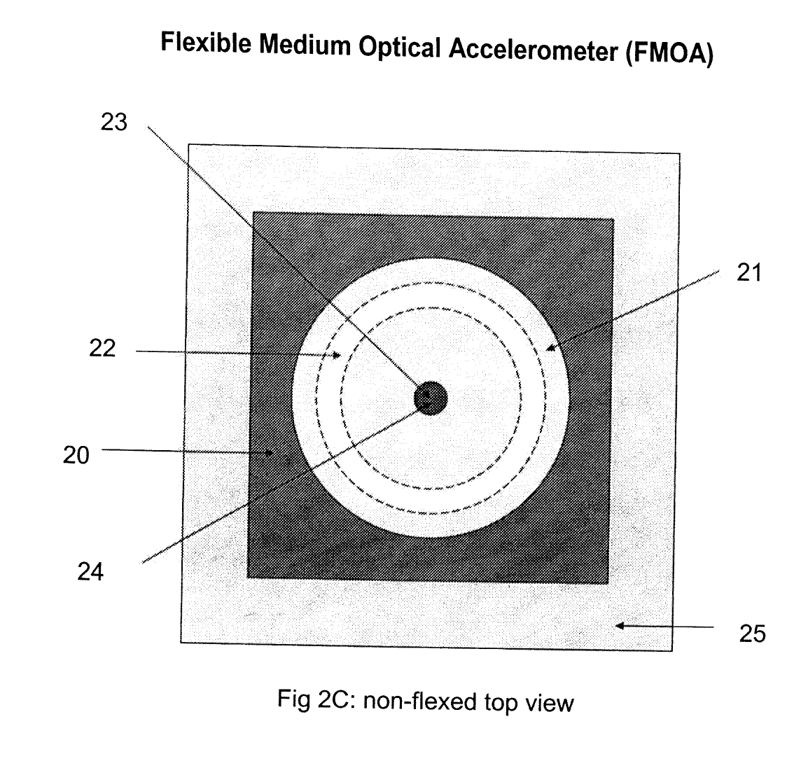

FIGS. 2A, 2B and 2C illustrate an implementation of the present invention which uses two plates, (a base plate 20 and a shifting plate 21) and a flexible medium 22 (e.g. foam, spring). The flexible medium 22 is used to connect the two plates. On the base plate 20 one of the light devices (e.g. light detector 24) is mounted, the base plate 20 is also mounted to a platform 25. On the shifting plate 21 the other light device (i.e. light source 23) is mounted. When the platform 25 experiences any acceleration or deceleration, the shifting plate 21 moves or shifts relative to the platform 25 and base plate 20 and this movement causes the light beam 26 to shift, as shown in FIG. 2B. This shifting of the light beam 26 causes the amount of light energy, the amount of radiant energy that is being directed to the light detector 24, to change and this in turn causes a corresponding change in the electrical signal that the light detector 24 produces. The electronic controller then processes this change in this electrical signal. FIGS. 2A and 2C are side and top views respectively of this embodiment when it is not experiencing any acceleration or deceleration. FIG. 2B is the side view of this embodiment when it is experiencing acceleration or deceleration.

Flexible Medium with Window OA (FMWOA)

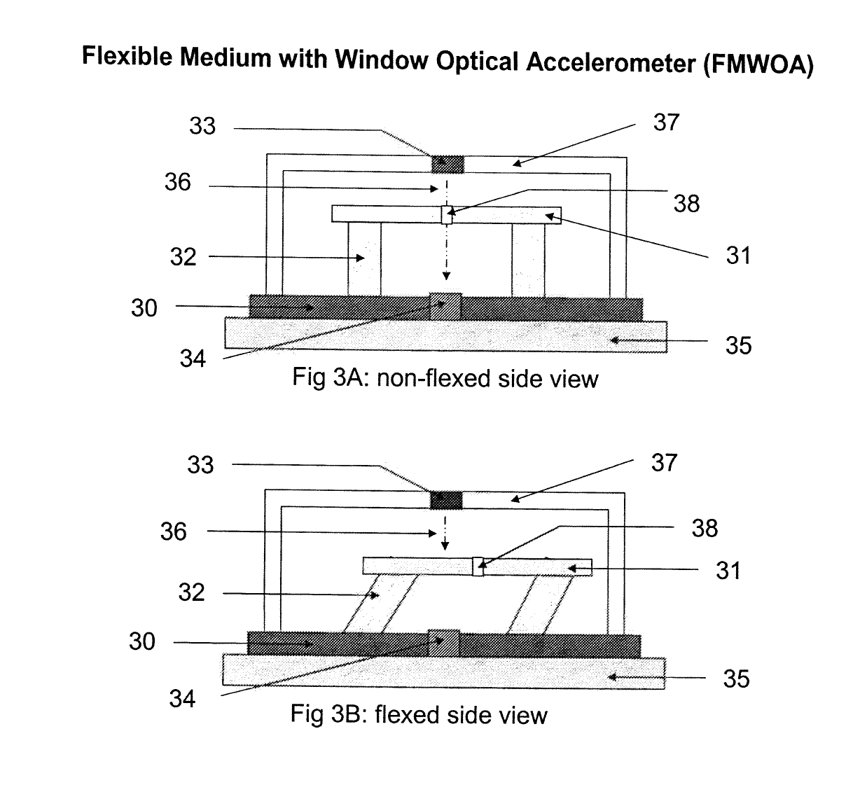

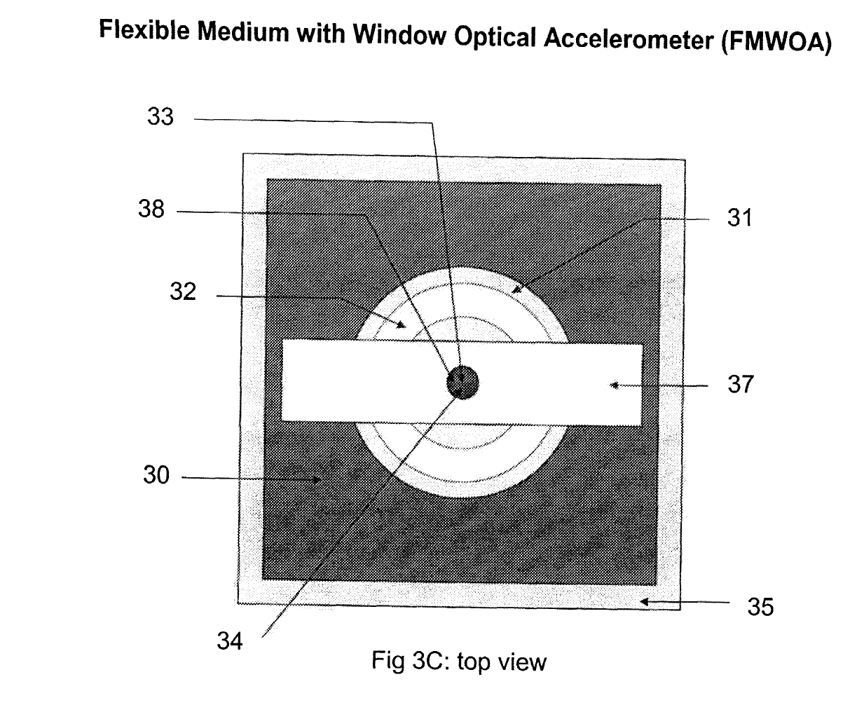

FIGS. 3A, 3B and 3C illustrate another implementation of the present invention. As in the first embodiment described above, this embodiment has two plates, (a base plate 30 and shifting plate 31) and a flexible medium 32 (e.g. foam, spring). Again, the flexible medium 32 is used to connect the two plates. Also, as in the previous implementation, one of the light devices (e.g. light detector 34) is mounted on the base plate 30 and the base plate 30 is mounted on a platform 35. However, this embodiment includes a shifting plate 31 that has a hole or window 38 and a support structure 37 on which the other light device, (i.e. light source 33) is mounted. When the platform experiences either acceleration or deceleration, the shifting plate 31 will shift relative to the platform 35 and base plate 30 as shown in FIG. 3B. When this occurs, the light bean 36 that was passing through the shifting plate window 38 changes. This change in light energy, the amount of radiant energy that is being directed to light detector 34, changes and this in turn causes a corresponding change in the electrical signal that the light detector 34 produces. The electronic controller then processes this change in this electrical signal. FIGS. 3A and 3C are side and top views respectively of this embodiment when it is not experiencing any acceleration or deceleration. FIG. 3B is the side view of this embodiment when it is experiencing acceleration or deceleration.

Flexible Medium with Directional Sensing OA (FMDSOA)

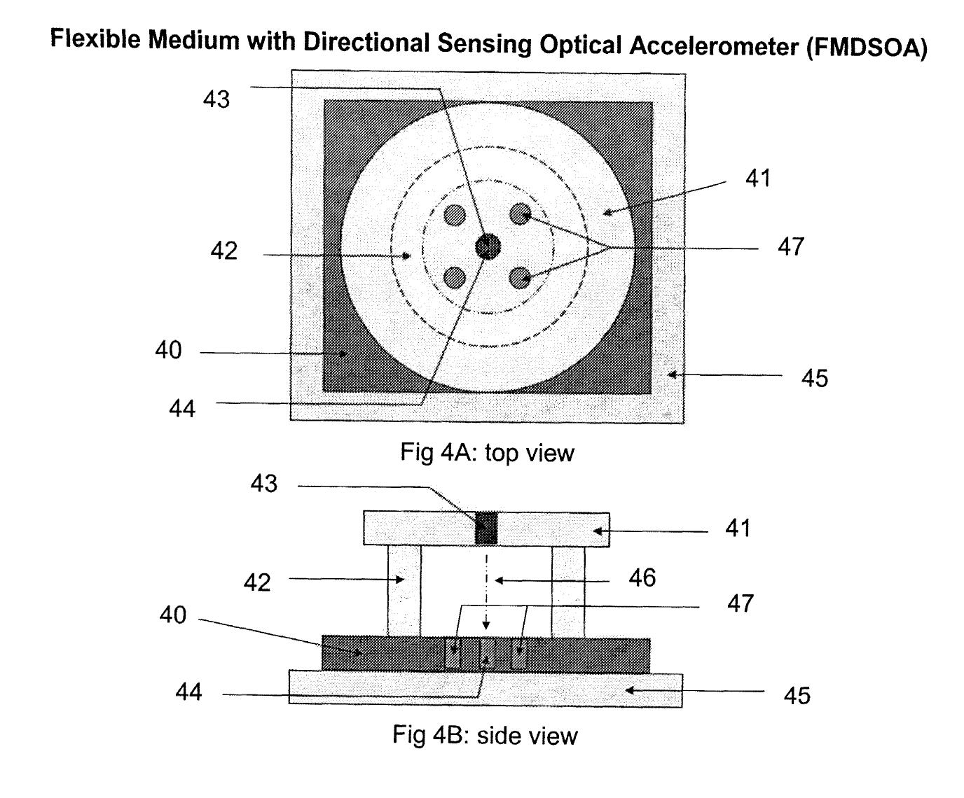

FIGS. 4A and 4B illustrate a top and side view of an implementation of the present invention which functions to determine the direction in which the acceleration or deceleration has occurred. With the addition of directional light detectors 47, either of the OA implementations previously presented, is capable of determining the direction of the acceleration or deceleration. These directional light detectors 47 surround the primary light detector 44 and provide directional information once the primary light detector 44 detects any acceleration or deceleration. The number of directional light detectors 47 will determine the direction's accuracy of the OA. The more directional light detectors 47 that are used, the higher the directional accuracy. Once the controller senses either acceleration or deceleration through the primary light detector 44, it then examines the electrical signal from each of the directional light detectors 47. From this information, the controller is able to determine the direction of the acceleration or deceleration. FIG. 1 illustrates a block diagram of the OA and the controller mounted on a platform.

In accordance with the present invention it should be understood that the flexible medium can for example, be polyurethane foam, a spring or any similar material that will react to acceleration or deceleration by movement in a direction opposite to the incident acceleration or deceleration.

It will be apparent to one skilled in the art related to the present invention that many modification and variations of the present invention are possible in the light of the teachings set forth above. It is therefore to be understood that within the scope of the appended claims the invention may be practiced in various ways other than what is specifically described herein.

I claim:

1) An optical accelerometer comprising;
a light source
a light detector
a flexible medium positioned between said light source and said light detector, said flexible medium having an opening, and
a light beam from said light source traveling through said opening to reach said light detector, whereby movement of said flexible medium results in a variation in the intensity of the light beam detected by said light detector.

2) An optical accelerometer in accordance with claim 1 wherein said flexible medium is a spring.

3) An optical accelerometer in accordance with claim 1 wherein said flexible medium is made of foam.

4) An optical accelerometer in accordance with claim 1 wherein said light source is mounted on a first plate and said light detector is mounted or a second plate and said flexible medium is positioned between said first and second plates.

5) An optical accelerometer in accordance with claim 1 wherein said light source is mounted on a support structure above said first plate and said first plate includes an aperature through which said light beam passes.

6) An optical accelerometer in accordance with claim 1 wherein there are a plurality of light detectors arranged in a circular arrangement opposite said light source.

7) An optical accelerometer comprising;
a light source,
a plurality of light detectors arranged in a circular arrangement opposite said light source,
a flexible medium positioned between said light source and said light detector, said flexible medium having an opening, and
a light beam from said light source traveling through said opening to reach one or more of said plurality of light detectors, whereby
movement of said flexible medium results in a variation in the intensity of the light beam detected by said light detectors.

8) An optical accelerometer in accordance with claim 7 wherein an electrical signal is produced by one or more of said plurality of light detectors in response to said light beam.

9) An optical accelerometer in accordance with claim 8 wherein a direction of acceleration or deceleration is determined in response to said electrical signal.

10) An optical accelerometer in accordance with claim 9 wherein the accuracy of determining the direction of acceleration or deceleration is dependent on the number of light detectors.
